(19) United States
(12) Patent Application Publication
(10) Pub. No.: US 2005/0098002 A1
(43) Pub. Date: May 12, 2005

(54) Magnetic screw-holding device

(75) Inventor: Martin Holland-Letz, Neustad/Hessen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Felo-Werkzeugfabrik Holland-Letz GmbH, Neustad/Hessen (DE)

(21) Appl. No.: 10/919,520

(22) Filed: Aug. 16, 2004

(30) Foreign Application Priority Data
Aug. 18, 2003 (DE) 203 12 920.2
Aug. 28, 2003 (DE) 103 42 033.9

(51) Int. Cl. B25B 23/08

(52) U.S. Cl. 81/451

(57) ABSTRACT

A magnetic screw-holding device is assembled close to the profile tip on the shank of a hand-screwdriver or screwdriver-insert with long shank. The device essentially consists of a sleeve made of non magnetic-conducing material in which a magnet is fixed at the front side or of a magnet made of magnetic material embedded in a plastic binder produced by injection molding. The sleeve with the magnet or the magnet can easily move in longitudinal direction and is or can be brought into such a position relative to the profile tip that by the force of the magnet-field the sleeve or the magnet moves automatically into a position in which the front face of the magnet contacts the surface of the screw head and also attracts the screw onto the profile tip so that it completely penetrates into the recess in the screw head if a screw is placed on the profile tip.

### CLAIM OF PRIORITY

This application claims priority to German patent applications 203 12 920.2, filed on Aug. 18, 2003, and 103 42 033.9, filed on Aug. 28, 2003. The contents of German patent applications 203 12 920.2 and 103 42 033.9 are incorporated in their entireties herein by this reference.

### FIELD OF THE INVENTION

The present invention concerns a magnetic device for hand screwdrivers and screwdriver inserts with a long shank to hold screws on the profile tip of the driver.

### BACKGROUND OF THE INVENTION

There are magnetic devices on the market or known from the patent literature which are designed to be an adapter for short screwdriver-inserts and are equipped with a permanent magnet to hold screws on the tip of the screwdriver-inserts. These kinds of magnetic screw-holding devices are described in U.S. Pat. Nos. 3,392,767, and 5,724,873 and in DE 101 48 943.9 and DE 199 07 837. EP 1 027 959 A2 describes a magnetic screw-holding device which is assembled on the front part of a screwdriver insert with a long shank. For all of these devices, the magnets are disposed at a predetermined distance from the screw or screwdriver tip. According to the device for short screwdriver inserts in DE 199 07 837, by means of a thread-ring with a ring magnet assembled on the socket which holds the screwdriver-inserts, the magnet can be manually adjusted to contact the screw head. It would be of remarkable advantage if the magnetic screw-holding device were to adjust itself automatically, not only to different screw sizes but also to compensate for production tolerances at the profile of the recess in the screw head. According to EP 1 260 313 a magnetic screw-holding device is designed as an adaptor for short screwdriver-inserts, but the magnet is fixed in a sleeve which is movable on the adaptor-socket.

The magnetic screw-holding devices mentioned before are relatively large in diameter. This is of disadvantage if screws are to be inserted into narrow casings or borings, especially if the screw is placed deeper in the casing or hole. The short adapters for screwdriver inserts are not typically suitable for such an application.

Holding devices for screws are desirable also for hand-screwdrivers or screwdriver-inserts with long shanks to reach deep-seated places. In many cases, it is not possible to reach that place with the user's second hand to hold the screw. A screw falling off from the screwdriver tip may even cause damage to an apparatus or electrical appliance. At jobs which require the operator to screw overhead, a screwholder device would also be very helpful.

On the market are mechanical screw-holding devices which either clamp the screw head at its circumference or from the inside of the recess in the screw head. The function of this kind of devices is often not reliable, and the screw is not held in a position co-axial to the screwdriver-shank which makes it difficult to insert the screw straight, for example into a thread-hole.

The task is to develop a screw-holding device with a permanent magnet which can be assembled on the shank of hand screwdrivers, or of screwdriver-inserts having a long shank, which has a small outer diameter and is automatically self-adjusting to hold screws of different sizes but with the same recess-profile firmly on the profile tip when a screw is put on the profile tip. A small diameter and low weight are sought also because this kind of device with small overall dimensions is preferably suitable also for small hand screwdrivers. The outer diameter of the device preferably does not exceed the diameter of the screw head if even possible to allow access to narrow areas. The screw is held stable in a position co-axial with the axis of the screwdriver shank.

### BRIEF SUMMARY OF THE INVENTION

The screw-holding device according the present invention comprises a permanent magnet—called a magnet herein—assembled on a screwdriver shank close to a profile tip and is easily movable on the shank in a longitudinal direction. A first embodiment of the invention comprises a sleeve made of non magnetic-conductive material, preferably aluminum or plastic material, in which a short ring magnet is fixed at the front side. The sleeve with the magnet is easily movable. In a second embodiment, the magnet itself has the shape of a sleeve which is longer than the ring magnet but smaller in diameter. A magnet of this kind comprises magnetic material which is embedded in plastic binder and produced by injection molding or pressing, for example. With the rear part the magnet is inserted in a sleeve preferably made of plastic material, or the magnet is totally encompassed by the plastic sleeve as protection with the exception of the front side face, for example. The device with the sleeve-shaped magnet offers the advantage that the diameter is even smaller than the diameter of the device with the ring magnet.

To achieve the maximum of magnetic holding force, the magnet and the screw head contact each other because any gap between the magnet and screw head reduces the force of the magnetic field considerably. A further effect of direct contact of the screw head with the magnet is that the screw is held straight in an axial direction of the screwdriver shank. As the depth of the recess in the head of screws of different size but of the same type of recess, for example of Phillips 2 or Posidrive 2 or Torx 20, is different, the magnetic holding device is adjustable to a position relative to the profile tip such that the direct contact of the magnet and screw head is achieved. This can be done by hand as described for the device according DE 199 07 837 by means of a thread-ring with an inserted magnet. The depth of the recess, however, is also different for screws of the same size due to manufacturing tolerances. It is very awkward to adjust the magnetic holding device by hand to compensate for tolerances in the recess for a number of screws of the same size. To compensate for these tolerances, the magnetic holding device is adjustable automatically for screws of the same type and for different depths of the recess due to different sizes of the screw.

To enable the magnetic device to adjust itself automatically, the device is disposed in a particular position relative to the profile tip of the screwdriver and can move axially within given limits. The limits are determined by a stop ring fixed on the screwdriver shank encompassed with radial play by the sleeve in which the ring magnet or the sleeve-shaped magnet is fixed. A boring with the length T2 in the sleeve is longer than the length B of the stop ring so that the sleeve can move in forward and backward directions. Before a screw is placed onto the profile tip, the sleeve stands in a position at which the stop ring has approximately a middle position in the boring and the profile tip protrudes out of the opening in the magnet by a short length. If a screw is placed onto the profile tip, the sleeve with the magnet moves forward and the magnet contacts the screw head. The maximum movement in the backward direction is limited by the contact of the magnet with the rear face at the stop ring, the movement in the forward direction is limited by contact of the step in the boring of the sleeve with the stop ring. This construction principle is applied in the first and second embodiments of the invention.

In an alternative embodiment of the invention, the inner diameter of the ring magnet is chosen larger than the diameter of the stop ring. The sleeve with the magnet then can be moved backward by hand over the stop ring into a position more distant from the profile tip. In this position, the magnetic force is not, or only weakly, reaching as far as to the profile tip and possibly does not hold a screw anymore, but it may be useful if a screw has to be reached in a very narrow boring or other narrow space into which the sleeve would not fit.

The function of the automatic adjustment of the device will be explained in more detail with the explanation of the drawings.

The embodiments as described before are suitable for screwdrivers at which the diameter of the profile tip is not larger than the diameter of the screwdriver shank. Screwdrivers for larger slotted screws profile tips are usually forged and their width is larger than the diameter of the shank. A sleeve with a ring magnet or a sleeve-shaped magnet can not be assembled onto the shank from the tip end. In a third embodiment of the invention, the magnet consists therefore of two pieces which are completely made of magnetic material with plastic binder by injection molding. Their inner shape is formed according to the shape of the screwdriver tip but with play so that an axial movement of the magnet is possible. The inner shape at the rear part of the magnet is adapted to the diameter of the screwdriver shank forming a circular hole when both parts are put together. The hole serves as a guide for the magnet to move easily on the shank. Both parts of the magnet are held together after assembling them on the screwdriver shank preferably by a ring-spring or are glued together. Between the inner shape adapted to the shape of the screwdriver tip and the circular hole in the rear part, in the middle part a circular hole with a larger diameter than in the rear part is provided. In this area a stop ring is fixed onto the shank. The measurement of the inner shape of the magnet, the measurement of the stop ring, and the position of both on the shank relative to the profile tip are determined such that when a screw is put onto the profile tip, the magnet is attracted by the screw head and automatically moves forward in the direction of the screw until the magnet contacts the surface of the screw head. At the same, time the magnetic force attracts the screw onto the profile tip so that it penetrates completely into the recess in the screw head.

GB 869,431 describes a magnetic holding device which consists also of two parts which are shaped to fit a forged screwdriver tip. This magnetic holding device can not be moved axially by the magnetic force when a screw is placed on the screwdriver tip. Also a magnetic holding device according U.S. Pat. No. 2,688,991 can not move automatically.

The stop ring spring-rings may be made of metal or plastic, for example, and fixed with press-fit or glued to the shank, for example. In the examples shown by the drawings, the stop ring is tubular shaped. A spring ring preferably assembled in a circular groove in the shank may also serve as stop ring. If the stop ring is made of ferrous material, the rear field of the magnet may be influenced and by this the position of the sleeve or magnet relative to the profile tip. The magnetic attraction in the direction of the stop ring may become so strong that the magnet will not move automatically in the direction of the screw if the screw is small. If the first stop ring is made of ferrous material, the size of the stop ring and the magnetic force of the magnet can be adjusted to achieve the automatic function as desired.

As the magnetic material, rare earth materials, preferably neodymium, can be used. All kinds of magnets are magnetically polarized in an axial direction.

The device is assembled in that way that at first the sleeve without the magnet is put on the shank, then the stop ring is pressed onto the shank and finally the magnet is fixed in the sleeve.

### BRIEF DESCRIPTION OF THE DRAWINGS

FIG. 1 is a side view of a screwdriver with a magnetic screw-holding device at the tip of the screwdriver shank according to the present invention;

FIG. 2 is a longitudinal section through the screw-holding device along line 1-1 in FIG. 1 with a ring magnet;

FIG. 3 is a longitudinal section through the screw-holding device with ring magnet in a position in which the head of the screw contacts the magnet and the profile tip with a Torx profile penetrates into the screw head;

FIG. 4 is a longitudinal section through the screw-holding device as shown in FIG. 3 but with a ring magnet with inner diameter larger than the diameter of the stop ring.

FIG. 5 is a longitudinal section according to FIG. 3 but with a profile tip of Phillips type.

FIG. 6 is a longitudinal section through the screw-holding device of a second embodiment according to the present invention with the magnet shaped as sleeve;

FIG. 7 is a longitudinal section through the screw-holding device of a third embodiment according to the present invention;

FIG. 8 is a front view on the screw-holding device according to FIG. 7;

FIG. 9 is a view on a forged screwdriver tip and the parts of the magnet of the third embodiment lying open.

### DETAILED DESCRIPTION OF THE INVENTION

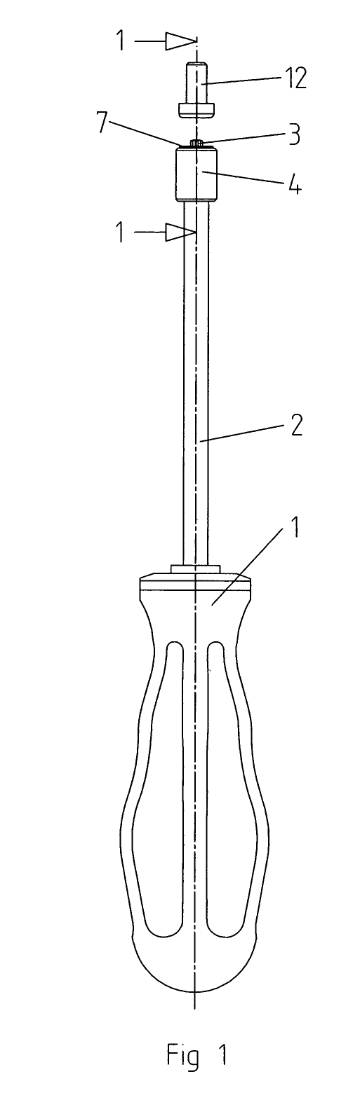

Referring to the drawings, FIG. 1 shows a hand screwdriver consisting of the handle 1, the shank 2 with the profile tip 3. Assembled on the shank is the sleeve 4 in which the ring magnet 7 is inserted. A screw 12 is in position to be put onto the profile tip 3.

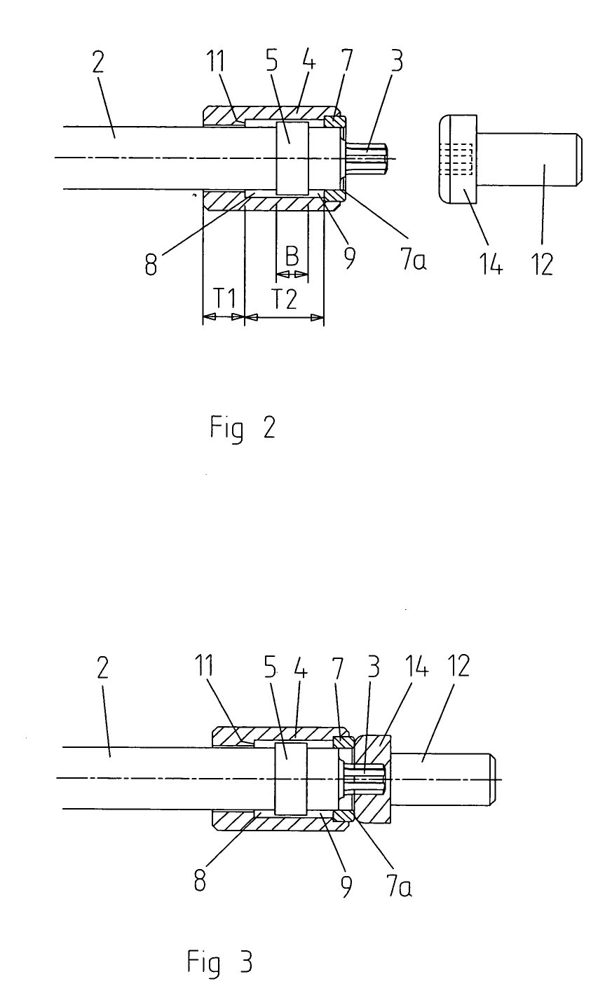

FIG. 2 shows the details of the construction of the magnetic screw holding device according to a first embodiment of the invention. Into the tubular sleeve 4, made of non magnetic conducing material, the ring magnet 7 is fixed by press seat or by glue, for example. A boring in the sleeve has a length T2, and the stop ring has the length B. T1 is the length of a smaller boring in the sleeve in which the sleeve is guided on the shank so that the sleeve can easily move. The stop ring 5, a tubular sleeve at the illustrated example, is fixed on the shank 2 in a defined position relative to the profile tip 3 so that a clearance 8 between the stop ring 5 and the step 11 in the boring of the sleeve at one side and between the stop ring and the magnet 7 at the other side 9 allow the sleeve 4 to move on the shank 2 in both directions. The screw 12 has a head 14 with a recess 15 and a head diameter K. The clearance 8 is sized to allow the sleeve to move in a direction toward the profile tip 3 so that the front face 7a of the magnet contacts the rear surface of the screw head 14 if the screw were put onto the profile tip. The length of clearance 9 is determined to avoid the sleeve 4 being moved in the direction off from the profile tip by the magnetic force so far that the magnetic attraction force between the magnet and the screw head is not sufficient any more to move automatically the sleeve in a direction toward the screw head and bring the magnet in contact with the screw head.

The process of the automatic adjustment of the magnetic screw-holding device can be as follows: the sleeve 4 with the ring magnet 7 or a sleeve-shaped magnet which can easily move on the screwdriver shank takes indifferent positions on the shank if it is brought into a position far off from the tip of the shank. If it is brought, however, into a position close to the tip it takes a defined position in which the front face 7a of the magnet has a certain distance from the tip. The explanation is believed to be that the magnetic flux at the back side of the magnet is closed through the shank whereas at the front side of the magnet the gap between the magnet and the profile tip—which is reduced in diameter and/or mass by the profile—reduces the magnetic force exerted onto the sleeve with the ring magnet or the sleeve-shaped magnet with the consequence that by axial movement the magnet takes a position in which the magnetic forces at both pole sides are balanced. This position is called the “stand-by position” in the following text. FIG. 2 shows the device in the stand-by position.

If a screw head 14 is brought in a short distance from the front face 7a of the magnet, the magnetic flux is closed to a wide extent through the screw head, which is larger in diameter than the shank. Consequently, the magnetic force at the front side becomes stronger and pulls the magnet in direction to the screw head bringing the front side 7a and the screw head in contact.

At the same time the magnetic force at the rear side of the magnet still exerts a force off from the tip in the direction toward the shank. By this force, the screw head sticking at the front side of the magnet is pulled onto the profile tip up to the full penetration of the profile tip into the recess in the screw head and full contact of the positive profile of the tip with the negative profile of the recess is obtained. To start this process, the magnet has a defined distance from the end of the profile tip in the stand-by position. This stand-by position can be found by trials testing magnets with different dimensions and different magnetic force inserted in the sleeve. The sleeve takes different positions relative to the profile tip with different magnets. With the largest and smallest screw of a particular type it is tested whether the sleeve moves automatically in the direction toward the profile tip, contacts the screw head and attracts the screw with sufficient force onto the profile tip. Because different magnets will take a stand-by position at different distances from the profile tip end, the lengths of the clearances 8, 9 can be adjusted accordingly for different magnets so that the required distance of movement is possible.

The distance of the magnet from the end of the profile-tip in the stand-by position was found to depend not only on the magnetic force of a magnet but also on the type of the profile tip. The stand-by position of the same magnet on a shank with same diameter was found to be different in combination with a Torx profile tip or a Phillips-profile tip.

For a magnet of the third embodiment, the volume and the distribution of the substance is adjusted by the construction and by tests to achieve that the magnet takes a stand-by position from which the automatic adjustment process starts as described.

Due to considerations of economy, it may be suitable not to find out the optimal size of the magnet by tests with each different profile tip but to select a magnet which in the stand-by position has a somewhat longer distance from the end of the profile tip and the movement in the direction toward the screw head does not start automatically if a small screw is put onto the profile tip. A light touch with a finger can move the sleeve or the magnet forward and start the automatic adjustment process. Starting the movement of the magnet from such a stand-by position there will be a strong magnetic force in the direction toward the shank pulling strongly the screw head onto the profile tip. This would not be the case if a stand-by position nearer to the end of the profile tip were chosen, especially for a Phillips profile, because the flutes of the profile reduce the magnetic conduction at the rear side of the magnet.

If the profile tip is extracted from the screw head, the magnetic holding force may be so strong that the sleeve or the magnet move forward as far as the step in the boring of the sleeve or that the magnet strikes on the rear side of the stop ring. Then the magnet will be pulled off from the screw head and will return into the stand-by position.

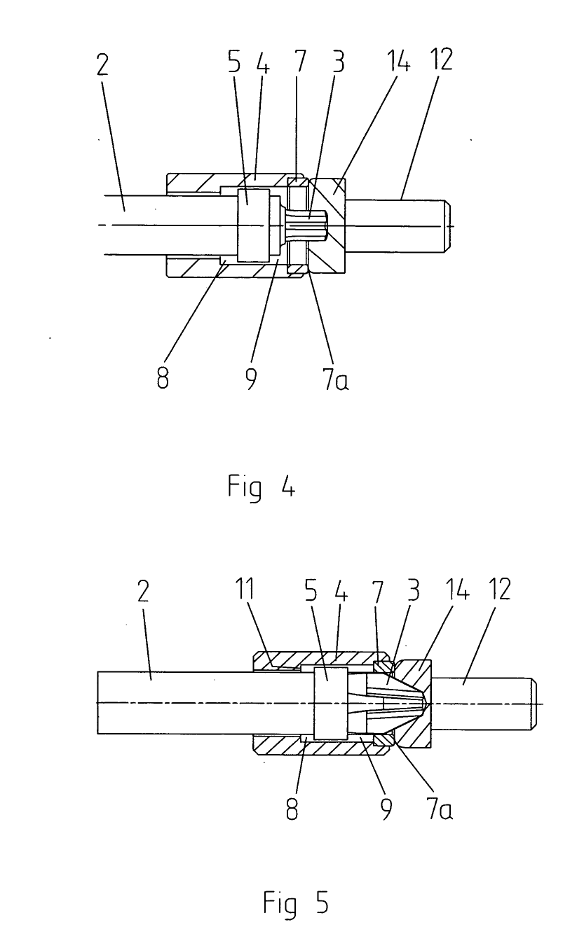

In FIG. 3 a screw is put on the profile tip. Comparing FIG. 2 and FIG. 3, it is seen that the sleeve 4 is pulled a short distance forward in the direction toward the profile tip 3 by the magnetic attraction force exerted between the magnet and screw head such that the magnet 7 has come into contact with the screw head. The profile tip has penetrated into the recess in the screw head up to the base. The ring magnet in FIG. 4 has an inner diameter larger than the outer diameter of the stop ring 5. The sleeve 4 with the magnet can be pulled backward onto the shank 2 so that the profile tip 3 and the front part of the shank can reach a screw placed in a narrow deep hole. In the embodiment according to FIG. 4, it is of advantage to make the stop ring of ferrous material so that the magnetic force holding the sleeve and magnet in the stand-by position relative to the profile tip is enforced. If the stop ring is made of non-ferrous material the sleeve and magnet can more easily be moved backward on the shank off from the determined stand-by position. FIG. 5 shows the device holding a screw of the Phillips type.

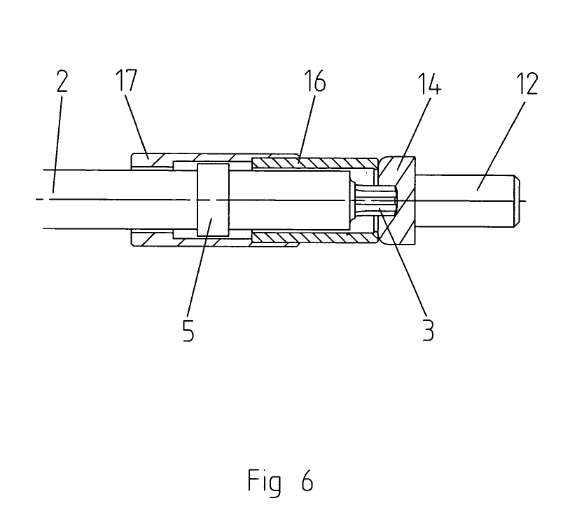

FIG. 6 shows a second embodiment of the invention with a sleeve-shaped magnet 16 with a relatively thin wall. The profile tip 3 penetrates into a screw head 14. The rear part of the magnet is inserted into the sleeve 17. It is of advantage if the sleeve encompasses the magnet as far as shortly before the front face—for protection of the magnet. The sleeve 17 is made of non magnetic-conductive material, preferably of plastic material or aluminum. The stop ring 5 is disposed between the magnet and the step in the boring of the sleeve. The position of the stop ring and the lengths of the clearances between the stop ring and the step in the boring at one side and the rear end of the magnet at the other side are determined in the same way as in the embodiment with ring magnet. It was found that for the sleeve-shaped magnet, a relation length to outer diameter greater than 1, at least 0.4, and a wall-thickness of 0.8 to 2.5 mm, depending from the diameter, is of advantage.

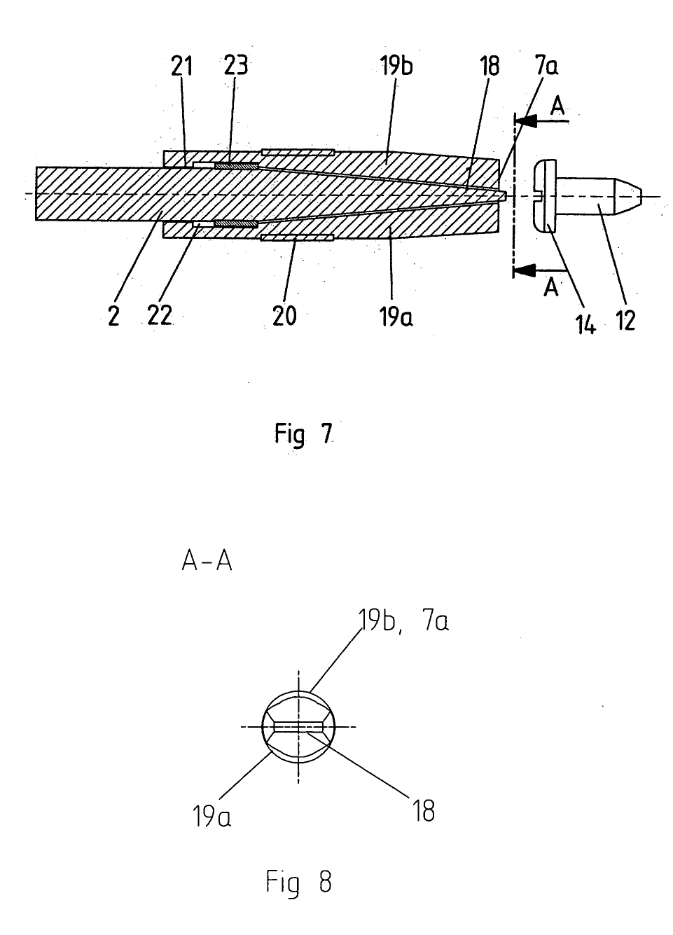

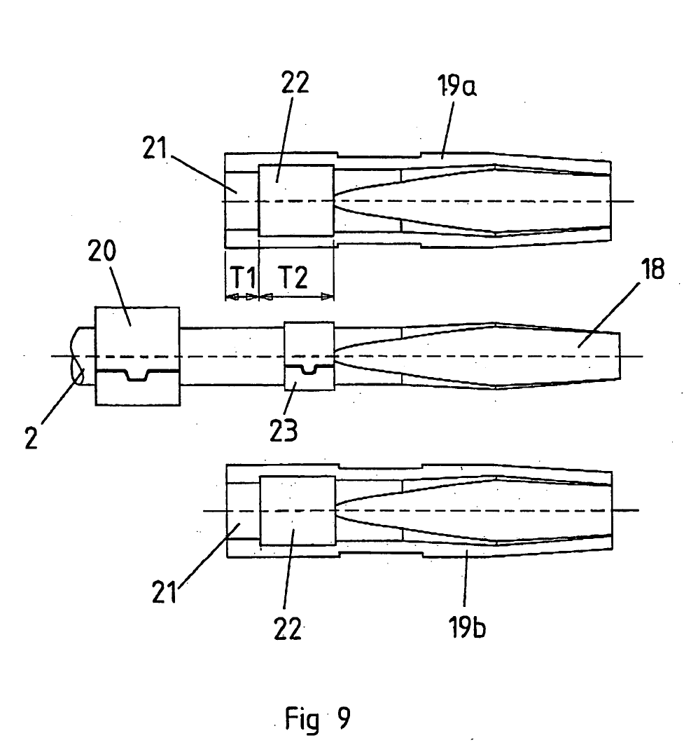

The longitudinal section FIG. 7 of the screw-holding device according to a third embodiment indicates that the magnet consist of the two pieces 19a and 19b which are encompassing the screwdrivers profile tip 18 with play and are held together by a ring-spring 20. The magnet is guided to move easily on the shank 2 by the boring 21 in the rear end of the magnet. The magnet stands in the stand-by position. The clearance 22 allows the magnet to move forward if the screw 12 is put onto the tip 18 and contact the screw head 14 with the front-face 7a of the magnet. In FIG. 8, the front face 7a of the magnet with the parts 19a, 19b and the profile tip 18 of a screwdriver for slotted screws are shown. In FIG. 9, a top view of the disassembled parts of the screw-holding device of the third embodiment is illustrated. There are to see the profile tip 18 and the inner contours of the two parts 19a, 19b of the magnet, which are shaped with play accordingly to the shape of the profile tip 18. Into the middle area of the parts 19a, 19b, a boring 22 is formed with a large diameter. Into the rear area of the parts 19a, 19b, a boring 21 is formed with a small diameter to slide on the shank 2. The area of the boring with a large diameter will accommodate with play the stop ring 23 when the device is assembled. The middle illustration shows the ring-spring 20 which will be moved forward and hold together the two parts of the magnet after they have been assembled on the screwdriver tip. The two parts of the magnet will react as a one-piece magnet after being assembled.

Magnetic screw-holding devices different from those as shown by the figures and described, consisting of other elements or being modified in other ways, will also be within the scope of the present invention, such as those that automatically adjust in that the magnet moves forward in a direction toward the profile tip, contacts the screw head and pulls at the same time the screw head onto the profile tip of the shank so that it fully penetrates into the recess of the screw head and holds the screw in co-axial position relative to the axis of the screwdriver shank.

The shank may have also another cross-section-profile than a round profile, for example a hexagon profile.

1. A magnetic screw-holding device assembled on a screwdriver shank close to the profile tip consisting essentially of a sleeve made of non magnetic-conductive material with a ring-shaped or sleeve-shaped permanent-magnet inserted in the front part of the sleeve or of a permanent-magnet assembled of two parts, the sleeve with the magnet or the magnet consisting of two parts are easily movable in axial direction on the shank within given limits and can be brought in such a position relative to the profile tip that when a screw is put onto the profile tip the magnetic force of the permanent-magnet moves automatically the sleeve with the magnet or the magnet consisting of two parts into such a position that the front face of the magnet contacts the screw head and at the same time pulls the screw onto the profile tip as far as that the profile tip penetrates into the screw head and comes to complete contact with the profile of the recess in the screw head.

2. A magnetic screw-holding device as specified in claim 1 standing on the screwdriver shank in such a position relative to the profile tip that the magnetic force of the permanent-magnet moves automatically the sleeve with the magnet or the magnet consisting of two parts into such a position that the front face of the magnet contacts the screw head and at the same time pulls the screw onto the profile tip as far as that the profile tip penetrates into the screw head and comes to complete contact with the profile of the recess in the screw head.

3. A magnetic screw-holding device as specified in claim 1 standing on the screwdriver shank in such a position relative to the profile tip that after being moved a short distance in direction to the profile tip by finger-touch the magnetic force of the permanent-magnet moves automatically the sleeve with the magnet or the magnet consisting of two parts into such a position that the front face of the magnet contacts the screw head and at the same time pulls the screw onto the profile tip as far as that the profile tip penetrates into the screw head and comes to complete contact with the profile of the recess in the screw head.

4. A magnetic screw-holding device as specified in claims 1 at which the sleeve with the ring magnet or the sleeve with the sleeve-shaped magnet or the magnet consisting of two parts has a boring a part of which with the length T1 is of small diameter at which the sleeve is guided on the screwdriver shank easily movable and an other part with length T2 with larger diameter encompasses with play the stop ring, the difference of the length T2 and the length B of the stop ring defines the determined distances of possible moves in both directions of the sleeves or the magnet consisting of two parts.

5. A magnetic screw-holding device as specified in claims 1 at which the possible movement of the sleeve with the ring magnet or with sleeve-shaped magnet or the magnet consisting of two parts in direction to the profile tip is limited by the contact of the step in the boring with the stop ring.

6. A magnetic screw-holding device as specified in claims 1 at which the inner diameter of the ring magnet or the sleeve-shaped magnet or of the front area of the magnet consisting of two parts is smaller than the outer diameter of the stop ring and the possible movement of the sleeve with the ring magnet or the sleeve-shaped magnet or the magnet consisting of two parts off from the profile tip is limited by the contact of the ring magnet, the sleeve-shaped magnet or the magnet consisting of two parts with the stop ring.

7. A magnetic screw-holding device as specified in claims 1 at which the stop ring is made of non magnetic-conducing material.

8. A magnetic screw-holding device as specified in claims 1 at which the stop ring is made of ferrous material.

9. A magnetic screw-holding device as specified in claims 1 at which the permanent magnet is a ring magnet.

10. A magnetic screw-holding device as specified in claims 1 at which the inner diameter of the ring magnet or the sleeve-shaped magnet is larger than the outer diameter of the stop ring.

11. A magnetic-screw-holding device as specified in claims 1 at which the permanent-magnet is sleeve-shaped, consists of magnetic material embedded in plastic binder and is produced by injection molding or by pressing.

12. A magnetic screw-holding device as specified in claims 1 at which the relation of length to diameter of the sleeve-shaped permanent-magnet is greater than 1, in minimum greater than 0,4.

13. A magnetic screw-holding device as specified in claims 1 at which the sleeve-shaped magnet has a wall thickness of 0,8 to 2,5 mm.

14. A magnetic screw-holding device a specified in claims 1 at which the permanet-magnet consists of two parts made of magnetic material embedded in plastic binder and produced by injection molding or by pressing, with an inner contour adapted to the contour of the profile tip and shank of the screwdriver with play so that the magnet can easily move in axial direction.

15. A magnetic screw-holding device as specified in claims 1 at which the dimensions of the elements, their positions to each other and on the screwdriver shank are determined by the construction in that way that the sleeve with the permanent magnet or the permanent magnet consisting of two parts are taking a predetermined position relative to the profile tip by the magnetic force.
